(19) United States
(12) Patent Application Publication
(10) Pub. No.: US 2015/0001983 A1
(43) Pub. Date: Jan. 1, 2015

(54) Corona Shield

(71) Applicant: Voith Patent GmbH, Heidenheim (DE)

(72) Inventors: Thomas Hildinger, Heidenheim (DE); Ludger Kodding, Heidenheim (DE); Marcelo Jacob Da Silva, Sao Paulo (BR); Joao Fiorini Cordeiro, Francisco Morato (BR); Camila Dos Santos Goncalves, Sao Paulo (BR)

(73) Assignee: Voith Patent GmbH, Heidenheim (DE)

(21) Appl. No.: 14/368,900

(22) PCT Filed: Nov. 23, 2012
(86) PCT No.: PCT/EP2012/073448

§ 371 Date: Jun. 26, 2014

(30) Foreign Application Priority Data
Jan. 10, 2012 (DE) 10 2012 000 290.4
Nov. 23, 2012 (WO) PCTEP2012073448

(51) Int. Cl. H02K 3/40; H01B 17/44; B05D 7/00; H01B 3/42

(52) U.S. Cl. CPC H02K 3/40; H01B 3/422; H01B 17/44; B05D 7/00
USPC 310/196; 174/140 CR; 427/104

(57) ABSTRACT

The invention relates to a corona shield for an electrical conductor in a rotating electric machine, comprising an outer corona shield and a terminal corona shield which is mounted adjacent to the outer corona shield, on a high-voltage insulation of the electrical conductor, and also comprising a strip that has a limited electrical conductivity, is arranged around the high-voltage insulation of the electrical conductor, and is impregnated with a resin. The invention is characterized in that a paint having a limited electrical conductivity is arranged at least between the high-voltage insulation and the strip, in the transition zone between the outer corona shield and the strip of the terminal corona shield.

The invention relates to a corona protection according to the kind as defined in closer detail in the preamble of claim 1. The invention further relates to a method for producing such a corona protection and an electrical machine with such a corona protection.

Electrical conductors with high-voltage insulation and corona protection are generally known and used in rotating electrical machines and high-voltage machines. A respective corona protection and a machine which uses such a corona protection are described for example in DE 102 27 226 A1. The corona protection, which typically comprises a so-called outer corona protection (OCP) and an end corona protection (ECP), is arranged on the high-voltage insulation attached to an electrical conductor. The so-called outer corona protection is typically situated in the region of the insulated electrical conductor which is arranged in grooves in the rotor or the stator in electrodynamic rotating machines. The end corona protection is typically arranged in the region of the electrical conductor which protrudes in the axial direction beyond the material of the rotor of the stator, which is typically a core stack.

It is described in the aforementioned German publication laid open for public inspection that such a corona protection is established on the basis of a tape, especially a textile material, a glass fibre matrix, a nonwoven material or the like. In order to ensure the limited electrical conductivity in the magnitude of approximately 10.5×10⁵ to 10.6×10⁶ Ωm which is conventionally used for corona protection, electrically conductive particles such as soot, silicon carbide or the like are typically arranged on this material. The aforementioned German publication proposes as an improvement to arrange fibres within the nonwoven material or the fabric in an electrically conductive manner and to thereby improve the configuration. Regardless of this fact, the tape for the corona protection is wound up on the outside of the high-voltage insulation of the electrical conductor and is subsequently impregnated with a resin and cured. The so-called VPI process (Vacuum Pressure Impregnation) is typically used for this purpose, which is also used in the production of the high-voltage insulation.

Despite careful work in the application of the corona protection, irregularities can occur frequently as a result of the configuration consisting of the wound tape and the subsequent impregnation with resin. It has been noticed that these irregularities, which can be caused for example by air pockets or by tapes that are not wound properly to 100% or the like, are especially relevant in the transitional region between the so-called outer corona protection and the end corona protection.

It is the object of the present invention to provide a corona protection for an electrical conductor in a rotating electrical machine which reduces the aforementioned disadvantages and problems in the transitional region between the end corona protection and outer corona protection.

This object is achieved in accordance with the invention by a corona protection with the features in the characterizing part of claim 1. Further advantageous embodiments are provided in the remaining dependent claims. A method for producing such a corona protection is also achieved by the features in the characterizing claim 11. Further advantageous embodiments of the method are also provided in the claims that are dependent thereon. Finally, claim 13 provides an electrical machine with such a corona protection or a corona protection produced according to the method.

It is provided in the corona protection in accordance with the invention that the outer corona protection is applied in the known manner to the high-voltage insulation of the electrical conductor. In the transitional region between the outer corona protection and the end corona protection, a lacquer with limited electrical conductivity is arranged between the high-voltage insulation of the electrical conductor and the tape which forms the conventional part of the end corona protection. Such a lacquer as an intermediate layer in the direct region of the transition between the outer corona protection and the inner region of the end corona protection which faces the high-voltage insulation allows a considerable improvement in the corona protection. Tests have proven this to the inventors.

The effect is presumably caused by the fact that the end corona protection overlaps the outer corona protection over a slight distance in the conventional configuration. Since a jump occurs in this overlapping region in the outer diameter of the insulated electrical conductor provided with the outer corona protection, the problem might be caused by this jump, producing irregularities in the winding of the tape and thus optionally in the impregnation thereof. This problem is remedied by the introduction of a lacquer which also has limited electrical conductivity, i.e. it also represents a corona protection on its part. Potential irregularities and defective places in the wound part of the end corona protection, especially due to the changing diameter, are now no longer situated in the corona protection arranged in accordance with the invention between the high-voltage insulation and the ambient environment, but between two regions of limited electrical conductivity, i.e. the lacquer layer on the one hand and the wound part of the end corona protection on the other hand. A considerable improvement can be achieved in this manner, which leads to a longer operational lifespan of the high-voltage insulation and the corona protection, and consequently leads to a decrease in the maintenance frequency when used in a rotating electrodynamic machine.

It is a further effect that as a result of the lacquer its application will fill up potential defective places which remain in the region of the outer corona protection in its production. This leads to a minimisation in the likelihood of electrical discharges in the region of defective places, which would lead to a destruction of the insulating material and the material of the corona protection.

It is provided in an especially favourable and advantageous further development of the corona protection in accordance with the invention that the tape of the end corona protection surrounds the entire length of the lacquer on the outside. The entire applied lacquer therefore lies in this especially favourable and advantageous embodiment within the tape of the end corona protection. It is thus ideally protected from potential damage from the outside. It can therefore be arranged in a very thin way, preferably only one layer.

It is further provided in a further embodiment of the corona protection in accordance with the invention that the lacquer is applied to the electrical insulation and overlaps the outer corona protection by a path distance. The lacquer is therefore not only applied laterally adjacent to the outer corona protection on the high-voltage insulation, but overlaps the outer corona protection in part. As a result, the especially critical region of the change in cross-section is also covered by the lacquer.

It can be provided in an advantageous further development of the corona protection in accordance with the invention that the lacquer is formed on the basis of resin, preferably alkyd resin. Such a lacquer can especially consist of the mixture of two resin components and a curing agent. In order to achieve the required limited electrical conductivity, the lacquer can also comprise electrically conductive and/or semi-conductive particles. Such particles are generally known from and used in the region of the production of corona protection tapes. They can be arranged both as conventional particles and also as nanoparticles. Such particles can also be introduced into a resin-based lacquer. The quantity used for this purpose is preferably 20 to 60% by weight of electrically conductive and/or semi-conductive particles relating to the entire weight of the lacquer. When nanoparticles are used, the fraction will typically rather lie in the lower regions of the aforementioned range.

The method in accordance with the invention for producing such a corona protection provides that an electrical conductor comprising the high-voltage insulation and the outer corona protection is provided with the end corona protection, for which purpose the transitional region of the high-voltage insulation is coated with the lacquer laterally adjacent to the outer corona protection and especially overlapping the same, whereupon the lacquer is dried and/or cured, and whereupon the tape of the end corona protection is wound up, impregnated with a resin and cured. The method for producing the corona protection in accordance with the invention thus provides that an additional step is integrated in the conventional production process for the corona protection. The electrically insulated conductor provided with the outer corona protection is thus coated in the transitional region with the lacquer. Once it has dried and/or cured, the tape of the end corona protection is wound up in the manner of a previously known and used end corona protection, impregnated with a resin and cured, e.g. within the scope of a VPI process.

An electrical machine with a corona protection is also part of the invention, wherein the corona protection is arranged in accordance with the invention and/or is produced by the method in accordance with the invention. Such an electrical machine can be arranged in particular as a rotating electrodynamic machine, e.g. as a motor, generator or also as a phase shifter.

It is provided in a further, highly advantageous embodiment of the electrical machine that it is arranged as a high-voltage motor/generator which has a nominal voltage of more than 15 kV.

Further advantageous embodiments of the corona protection, the method for its production and the electrical machine and its use are further provided in the remaining dependent claims and will be described below in closer detail by reference to the embodiment which is shown by reference to the drawings, wherein:

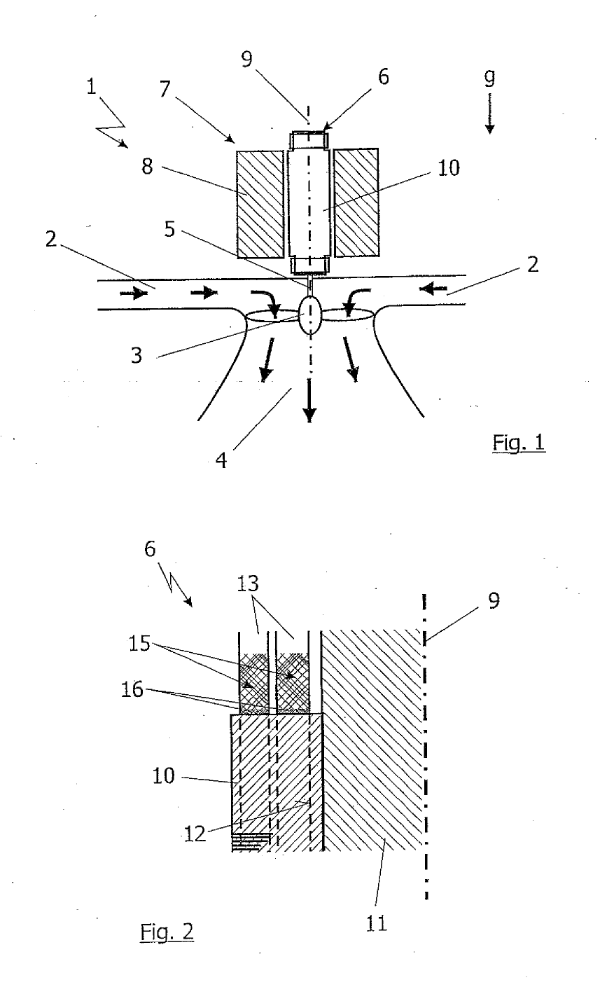

FIG. 1 shows a schematic representation of a machine set for a hydroelectric power plant;

FIG. 2 shows a sectional view of a part of a rotor of the machine set shown in FIG. 1, and

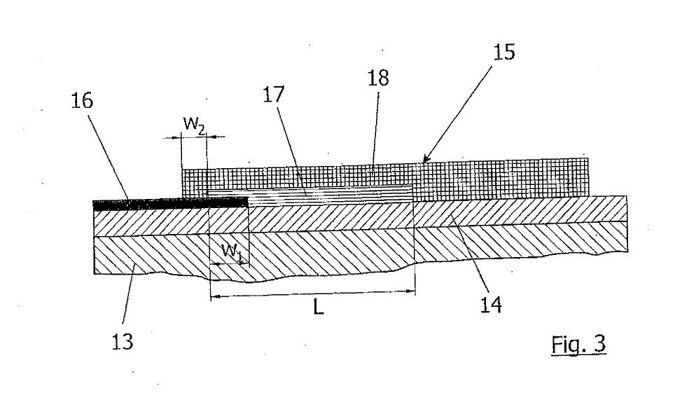

FIG. 3 shows a cross-sectional view through a preferred embodiment of the corona protection in accordance with the invention.

The illustration of FIG. 1 shows a highly schematic view of a hydroelectric power plant 1. The main element of the hydroelectric power plant 1 is a feed system 2, which conducts water from the region of the headwater (not shown) to a water turbine 3 and discharges water by a diffuser 4 (which is indicated in principle) to the region of the tailwater (also not shown). The water turbine 3 is connected via a shaft 5 to a rotor 6 of an electrical machine 7 to form the machine set. The rotor 6 is driven by the water turbine 3 and rotates within a principally indicated stator 8 about a rotational axis 9, which is aligned in the direction of gravity g, as is frequently the case in such hydroelectric power plants 1. The rotor 6 and the stator 7 jointly form the electrical machine 7 which is used as a generator. It is used for generating electrical power from the potential energy of the water. It is also possible to use a pump turbine instead of the water turbine 3, which in a first state produces power in the electrical machine 7 used as the generator similar to the water turbine 3, and which in a second operating state can pump water from the region of the tailwater back into the region of the headwater. The hydroelectric power plant 1 would be a pumped-storage power station in this case, which is suitable for storing energy by pumping water to a level of higher potential energy.

The sectional view of FIG. 2 shows a sectional view of a part of the rotor 6. It rotates about the rotational axis designated with reference numeral 9. The rotor 6 per se substantially consists of a core stack 10 and a hub designated with reference numeral 11. The configuration as a core stack 10 means that the rotor body is stacked up from a plurality of individual laminations in the axial direction of the rotational axis 9. This is symbolised by several indicated laminations in the illustration of FIG. 2 in the left bottom part of the illustrated sectional view. The hub 11 can be arranged integrally with the rotor body 10 and thus also consist of individual laminations, or it can be arranged as a central element in another configuration and carry the laminations of the rotor body 10 accordingly. Apart from the specific configuration, it is always the case that the hub 11 is connected in a torsion-proof way to the rotor body 10. Radial movements between the hub 11 and the rotor body 10 may occur.

Grooves 12 which extend in the axial direction and are outwardly open in the radial direction are situated in the region of the rotor body 10, of which in this case only the groove base is provided with the reference numeral 12. Two electrically insulated conductors 13, so-called bars 13, are inserted into these grooves 12. These bars 13 leave the grooves 12 in the region of the winding head and protrude in the axial direction of the rotational axis 9 out of the core stack 10. The individual bars 13 are then connected to further bars 13 which protrude out of the adjacent grooves 12 in order to thus realise the winding of the rotor 6.

The sections of the bars 13 which protrude beyond the core stack 10 in the axial direction are respectively fixed in the region of this winding head. This is irrelevant for the present invention, so that the known fixing is not shown for the purpose of simplifying the illustration. Comparable bars 13 can also be found in the stator 8 of the electrical machine 7.

The bars 13 comprise a high-voltage insulation 14 which is shown in the sectional view of FIG. 3 both in the rotor 6 and also in the stator 8, which high-voltage insulation surrounds the electrical conductor 13. It is typically arranged by a tape provided with mica particles, which is wound around the bar 13 and is subsequently impregnated with a resin, typically in a VPI process. This high-voltage insulation 14 is also irrelevant for the present invention, so that this item will not be discussed in closer detail. Alternatives are known from and used in the general state of the art in addition to the aforementioned example for arranging the high-voltage insulation by means of a mica tape. They could also be used accordingly in this case.

The so-called end corona protection 15 is situated in the region in which the bars 13 now protrude beyond the core stack 10, which end corona protection is also frequently abbreviated as ECP (End Corona Protection). The end corona protection 15 is a material layer of limited electrical conductivity or an electrical semiconductor which is applied on the outside to the high-voltage insulation 14. The so-called outer corona protection 16, which is also abbreviated with OCP, is situated in the region in which the bars 13 extend within the core stack 10 or the grooves 12 of the core stack 10. In the English-speaking countries this outer corona protection is also known as OCP (Outer Corona Protection). For illustration purposes, said outer corona protection 16 is drawn slightly over the core stack 10 in the part of the bars 13 which protrude beyond the core stack 10, before said outer corona protection 16 is followed in the known manner by the end corona protection 15.

This configuration is shown again in closer detail in the enlarged schematic sectional view of FIG. 3. The outer corona protection 16, which is shown in the drawing with the continuous black colour, is applied to the high-voltage insulation 14 in the left region shown in FIG. 3. It is arranged in the known manner. It can be arranged in such a way for example as described in the initially mentioned German specification laid open to public inspection. A lacquer 17 is applied to the high-voltage insulation 14 adjacent to the outer corona protection 16. The lacquer 17 has a total length of L and is arranged in the transitional region between the outer corona protection 16 and the end corona protection 15. It is part of the end corona protection 15. The lacquer 17 can be preferably applied in a single layer by a brush for example. It is arranged in the preferred embodiment as a lacquer 17 on the basis of an alkyd resin. It can comprise two different alkyd resin components for this purpose, e.g. a curing agent such as an acid-based curing agent, and silicon carbide particles for producing limited electrical conductivity. The fraction of silicon particles is 40% to 60%, preferably approximately 50%, of the total weight of the lacquer 17. In the event of using nanoparticles this fraction is 20% to 50%.

As an alternative to the arrangement of the lacquer 17 on the basis of an alkyd resin, it is also possible to provide a different configuration, e.g. on the basis of epoxy resin, polyurethane or the like.

In the especially preferred embodiment of the end corona protection 15 as shown here, the lacquer 17 overlaps the outer corona 16 by a distance w₁, so that secure and reliable contact between the material of the outer corona protection 16 and the lacquer 17 is ensured in any case. The distance w₁ can be 7 to 20%, preferably approximately 10%, of the total length L of the applied lacquer 17. The total length L of the applied lacquer 17 is obviously always dependent on the configuration and the boundary conditions of the individual electrical machine 7. It will be between approximately 50 mm and 200 mm in typical configurations. Accordingly, the distance w₁ would preferably be 5 mm to 20 mm.

After the application of the lacquer 17, which can occur by means of a brush for example as mentioned above, the lacquer 17 is dried at first, preferably for a time of at least one hour, in order to achieve the escape of volatile solvents. The lacquer 17 can then be cured in a furnace. Typical temperatures procuring lie in a range of 100° C. to 160° C. The time interval typically varies from 2 to 12 hours. Typical conditions could be curing at a temperature of 120° C. for 12 hours in a furnace. Once the drying and the curing of the lacquer 17 has been completed, the configuration can be provided in the known manner with a tape 18 for completing the end corona protection 15. This tape 18, which is either provided with particles of limited electrical conductivity or with respective fibres in a nonwoven material or fabric of the tape 17 with limited electrical conductivity, is wound in the known manner around the high-voltage insulation 14 of the bar 13, subsequently impregnated with a resin and cured. The configuration and the method can be realised precisely in a way that is also known and applied in a conventional end corona protection without the introduced lacquer 17.

It is provided in the special preferred embodiment of the end corona protection 15 that the lacquer 17 is surrounded over its entire length L by the tape 18 of the end corona protection 15, wherein this tape 18 extends beyond the total length L of the lacquer 17 on the side of the lacquer 17 facing away from the outer corona protection 16. Since the entire lacquer 17 comes to lie beneath the tape 18, it can be protected accordingly by the tape 18. A single applied layer of the lacquer 17 is therefore sufficient to achieve the improvement in the end corona protection 15.

In the embodiment shown in FIG. 3, it is further provided that the tape 18 protrudes beyond the total length L of the lacquer 17 and protrudes on its part beyond the outer corona protection 16 by a distance which is designated in the illustration of FIG. 3 with w₂. This distance w₂ can be arranged within the framework of conventional production tolerances with a preferably comparatively large size like the distance w₁ which overlaps the lacquer 17 of the outer corona protection 16. As in the embodiment as described above, the distance w₂ can therefore approximately be 5 mm to 20 mm. As a result, ideal protection of the lacquer 17 and good functionality of the corona protection in the configuration shown here is ensured.

1-34. (canceled)

35. A corona protection for an electrical conductor in a rotating electrical machine, the corona protection comprising:
an outer corona protection;
an end corona protection, which is attached adjacent to the outer corona protection to a high-voltage insulation of the electrical conductor; and
a tape with limited electrical conductivity, which is arranged around the high-voltage insulation of the electrical conductor and is impregnated with a resin;
wherein a lacquer with limited electrical conductivity is arranged in the transitional region between the outer corona protection and the tape of the end corona protection, at least between the high-voltage insulation and the tape, wherein the lacquer is applied to the high-voltage installation and overlaps the outer corona protection by a first distance, and wherein the tape protrudes beyond the total length of the lacquer and additionally overlaps the outer corona protection by a second distance.

36. The corona protection according to claim 35, wherein the lacquer is arranged at least laterally adjacent to the outer corona protection on the high-voltage insulation with a shorter overall length than wound around by the tape.

37. The corona protection according to claim 35,. wherein the tape surrounds the entire length of the lacquer on the outside.

38. The corona protection according to claim 36, wherein the tape surrounds the entire length of the lacquer on the outside.

39. The corona protection according to claim 35, wherein the first distance and the second distance correspond to 7 to 20%, preferably approximately 10%, Of the total length of the lacquer.

40. The corona protection according to claim 36, wherein the first distance and the second distance correspond to 7 to 20%, preferably approximately 1′0%, of the total length of the lacquer.

41. The corona protection according to claim 37, wherein the first distance and the second distance correspond to 7 to 20%, preferably approximately 10%, of the total length of the lacquer.

42. The corona protection according to claim 38, wherein the first distance and the second distance correspond to 7 to 20%, preferably approximately 10%, of the total length of the lacquer.

43. The corona protection according to claim 35, wherein the lacquer is applied in form of a single lacquer layer.

44. The corona protection according to claim 36, wherein the lacquer is applied in form of a single lacquer layer.

45. The corona protection according to claim 37, wherein the lacquer is applied in form of a single lacquer layer.

46. The corona protection according to claim 38, wherein the lacquer is applied in form of a single lacquer layer.

47. The corona protection according to claim 39, wherein the lacquer is applied in form of a single lacquer layer.

48. The corona protection according to claim 35, wherein the lacquer is formed on the basis of resin, preferably alkyd resin.

49. The corona protection according to claim 35, wherein the lacquer comprises electrically conductive and/or semiconductive particles and/or nanoparticles with a fraction of 20 to 60% by weight, preferably approximately 50% by weight, of the weight of the lacquer.

50. The corona protection according to claim 49, wherein the particles comprise silicon carbide or consist thereof.

51. A method for producing a corona protection for an electrical conductor in a rotating electrical machine, the corona protection including an outer corona protection, an end corona protection, which is attached adjacent to the outer corona protection to a high-voltage insulation of the electrical conductor, and a tape with limited electrical conductivity, which is arranged around the high-voltage insulation of the electrical conductor and is impregnated with a resin, wherein a lacquer with limited electrical conductivity is arranged in the transitional region between the outer corona protection and the tape of the end corona protection, at least between the high-voltage insulation and the tape, wherein the lacquer is applied to the high-voltage installation and overlaps the outer corona protection by a first distance, wherein the tape protrudes beyond the total length of the lacquer and additionally overlaps the outer corona protection by a second distance, and wherein the electrical conductor which is provided with the high-voltage insulation and the outer corona protection is provided with the end corona protection, the method comprising:
coating the transitional region of the high-voltage insulation between the outer corona protection and the end corona protection with the lacquer laterally adjacent to the outer corona protection, and overlapping with said outer corona protection, whereupon the lacquer is dried and/or cured, and whereupon the tape of the end corona protection is wound up protruding beyond the total length of the lacquer and additionally overlapping the outer corona protection by the second distance, impregnated with a resin and cured.

52. The method according to claim 51, wherein the lacquer is dried for at least 30 minutes, preferably for an hour, at ambient temperatures of 15 to 30° C., and is cured thereupon for at least one hour, preferably for at least more than 2 hours, at a temperature of 115 to 125° C.

53. An electrical machine with at least one electrical conductor, which includes a corona protection for an electrical conductor in a rotating electrical machine, the corona protection comprising:
an outer corona protection;
an end corona protection, which is attached adjacent to the outer corona protection to a high-voltage insulation of the electrical conductor; and
a tape with limited electrical conductivity, which is arranged around the high-voltage insulation of the electrical conductor and is impregnated with a resin;
wherein a lacquer with limited electrical conductivity is arranged in the transitional region between the outer corona protection and the tape of the end corona protection, at least between the high-voltage insulation and the tape, wherein the lacquer is applied to the high-voltage installation and overlaps the outer corona protection by a first distance, and wherein the tape protrudes beyond the total length of the lacquer and additionally overlaps the outer corona protection by a second distance.

54. The electrical machine according to claim 53, wherein its arrangement as a high-voltage motor/generator which has a nominal voltage of more than 15 kV.
